(19) United States
(12) Patent Application Publication
(10) Pub. No.: US 2009/0199096 A1
(43) Pub. Date: Aug. 6, 2009

(54) AUTOMATED GUI TEST RECORDING/PLAYBACK

(75) Inventors: Goran Pop-Jordanov, Ottawa (CA); Artur Krzysztof Ruszcynski, Kanata (CA)

Correspondence Address: AKERMAN SENTERFITT, P.O. BOX 3188, WEST PALM BEACH, FL, 33402-3188, US

(73) Assignee: INTERNATIONAL BUSINESS MACHINES CORPORATION, Armonk, NY (US)

(21) Appl. No.: 12/025,496

(22) Filed: Feb. 4, 2008

(51) Int. Cl. G06F 3/048

(52) U.S. Cl. 715/704

(57) ABSTRACT

A method of automated GUI test recording/playback. The method comprises the steps of recording a GUI action including at least one action step and a command corresponding to the recorded GUI action; searching existing commands in a command library to determine if there is a match of the recorded command with any command in the command library, wherein if no match is found, the recorded GUI action with the corresponding command is stored in the command library and an invocation is created in a script, and if a match is found, an invocation is created in the script; and at playback, executing the command, invoking the corresponding user action from the command library.

### FIELD OF THE INVENTION

The present invention relates to the field of software functionality testing, and, more particularly, to automated graphical user interface (GUI) testing.

### BACKGROUND OF THE INVENTION

Software programs are typically tested in order to detect and correct errors or defects before being placed into production or released for public use. Software testing is a process by which the quality of software programs can be assessed, as well as any errors or defects in the software detected and corrected. There are many approaches to software testing. Functionality testing is the process of verifying whether a software program meets its design and functional specification. In the process, functionality testing can identify potential problems, or “bugs,” and once those bugs are eliminated, functionality testing can verify that the fixes were successful and within applicable standards.

Functionality testing can be conducted manually or non-manually through automated testing. In comparison to manual testing, automated testing has the advantage of being fast, comprehensive, reliable, programmable, repeatable, and reusable. Conventional automated testing methods utilize scripting languages to enable a programmer to generate scripts or programs that may be run to test a software program. However, whenever new functionality is added to, or taken away from, the software program, the scripts must be edited manually to incorporate the new features or to remove the old features. This increases the time and expense of testing.

GUI test automation has been developed to ease the burdens of manual scripting. When a test developer interacts with an application under test, typically through the GUI, a capture tool simultaneously generates an automated test script that is configured to play back an equivalent sequence of interactions. The intended objective is to save time that would have otherwise been spent on hand-coding test scripts. However, a problem with recorded tests of this kind is that the tests can be expensive to maintain, mainly because the tests tend to be fragile and the recorded interactions tend to contain considerable content, but with little meaning about the intent of the interactions. The problem has been addressed so far by abandoning recording and using data-driven or keyword-driven testing approaches. Data-driven testing allows an application to be tested with a different set of input values to be sure that the application works as expected. In data-driven testing, the script reads data from an external storage site, such as a file or database, rather than relying on values hard-coded in the script. Such a separation makes tests logically simpler. A script containing several sets of hard-coded values can be very difficult to modify. Keyword-driven testing and table-driven testing are interchangeable terms that refer to an application-independent automation framework which separates much of the programming work from the actual test steps so that the test steps can be developed earlier and can often be maintained with only minor updates. Although the data-driven or keyword-driven testing approaches may lower the maintenance cost, they still require manual scripting.

### SUMMARY OF THE INVENTION

Accordingly, an object of the invention is to provide a method of automated GUI test recording/playback that solves the aforementioned problems. An object of the invention, more particularly, is to provide a method of automated GUI test recording/playback that uses recording in a different manner to maintain the advantage of avoiding manual scripting, while also providing a maintainability that is comparable to the keyword-driven testing approach.

According to one aspect, the present invention provides a method of automated GUI test recording/playback in which a script is generated. The method can comprise recording a GUI action including at least one action step and a command corresponding to the recorded GUI action; searching existing commands in a command library to determine if there is a match of the recorded command with any command in the command library, wherein if no match is found, the recorded GUI action with the corresponding command is stored in the command library and an invocation is created in the script, and if a match is found, no new command is created in the command library and an invocation is created in the script; and at playback, executing the command, invoking the corresponding user action from the command library.

According to another aspect, the present invention provides a system of automated GUI test recording/playback in which a script is generated. The system comprises a GUI action listener for recording a GUI action including at least one action step; a command stack listener for recording a command corresponding to the GUI action; a command library for storing the recorded GUI action with the corresponding command; a searching tool for searching existing commands in the command library to determine if there is a match of the recorded command with any command in the command library, wherein if no match is found, the recorded GUI action with the corresponding command is stored in the command library and an invocation is created in the script, and if a match is found, no new command is created in the command library and an invocation is created in the script; and a play-back tool for executing the command, invoking the corresponding user actions from the command library.

According to a further aspect, the present invention provides a computer-readable storage medium on which computer-executable codes are stored. The computer-executable codes, when loaded, causes the computer to perform the steps of recording a GUI action including at least one action step and a command corresponding to the recorded GUI action; searching existing commands in a command library to determine if there is a match of the recorded command with any command in the command library, wherein if no match is found, the recorded GUI action with the corresponding command is stored in the command library and an invocation is created in the script, and if a match is found, no new command is created in the command library and an invocation is created in the script; and at playback, executing the command, invoking the corresponding user action from the command library.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is an exemplary view of a test description as utilized according to an embodiment of the present invention.

FIG. 2 is a flow chart of exemplary steps of a method of automated GUI test recording/playback according to another embodiment of the present invention.

### DETAILED DESCRIPTION OF THE INVENTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations of methods, apparatus (systems) and computer program products according to embodiments of the invention. It will be understood that each block of the flowchart illustration, and combinations of blocks in the flowchart illustration, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart block or blocks.

The flowchart in the Figures illustrates the architecture, functionality, and operation of possible implementations of systems, methods and computer program products according to various embodiments of the present invention. In this regard, each block in the flowchart may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the flowchart illustration, and combinations of blocks in the flowchart illustration, can be implemented by special purpose hardware-based systems that perform the specified functions or acts, or combinations of special purpose hardware and computer instructions.

As mentioned above, the main drawback of the conventional GUI test automation tools is the poor maintainability. Once GUI actions are recorded, it is difficult to understand the meaning of the recorded steps. For example, a tool might record the following action steps:

button.click( );
keyboard.type(“projectName”);
button2.click( ).

For a user, it is not clear what the intention of this action was. The poor maintainability is also shown by the poor reusability of the existing code. For example, the current GUI recording/playback tools would contain 10 separate sequences of the same user actions if the actions are repeated 10 times. The maintainability problem further arises when the system under test changes, such as by adding or deleting a step. In this case, this change would have to be repeated 10 times in the scripts or all 10 times of repetition would have to be re-recorded.

In order to avoid the above problem, a keyword-driven approach may be used. In a keyword-driven approach, there is no recording, but rather a person writes the automated test script. For the above example, the script may look like:

| Action | Parameter |
|---|---|
| Create new project | projectName |

The sequence of the action would be hard-coded, for example, as follows:

click new project button,
enter <name> in project name field,
click OK button in create new project wizard.

This improves the maintainability in that it is easier for a user to understand the intention of the action and the same sequence only has to be implemented once and can be repeated multiple times. However, the drawback of a keyword-driven approach is that the action sequence would have to be changed manually whenever there is a change in the system under test (for example, adding a step for clicking on an “Next” button in the project creation wizard prior to OK button).

In order to improve maintainability of automated GUI testing, in the method and system of automated GUI test recording/playback according to the present invention, the recording is done on two parallel levels: the usual mouse/keyboard interaction level and the command level (undo/redo command stack). The recorded mouse/keyboard actions would be automatically grouped at the command level, creating semantic blocks. For the above example, the GUI test automation tool according to the present invention would create an entry in a command library “createNewProject” containing action sequence:

click new project button,
enter <name> in project name field,
click OK button in create new project wizard

The corresponding script might look like:

createNewProject(“projectName”).

This approach achieves a maintainability comparable to the keyword-driven approach because the script is much easier for the user to understand and the existing code can be reused by calling the command library. At the same time, the approach of the present invention also avoids the inconvenience of manual coding of the keyword-driven approach.

The maintainability of the approach of the present invention can be further improved by merging and adding parameters to the semantic blocks. For example, if a user wants to create another project “project2,” the tool, according to the present invention, would recognize the “createNewProject” command and consequently the script would look like:

createNewProject(“project2”).

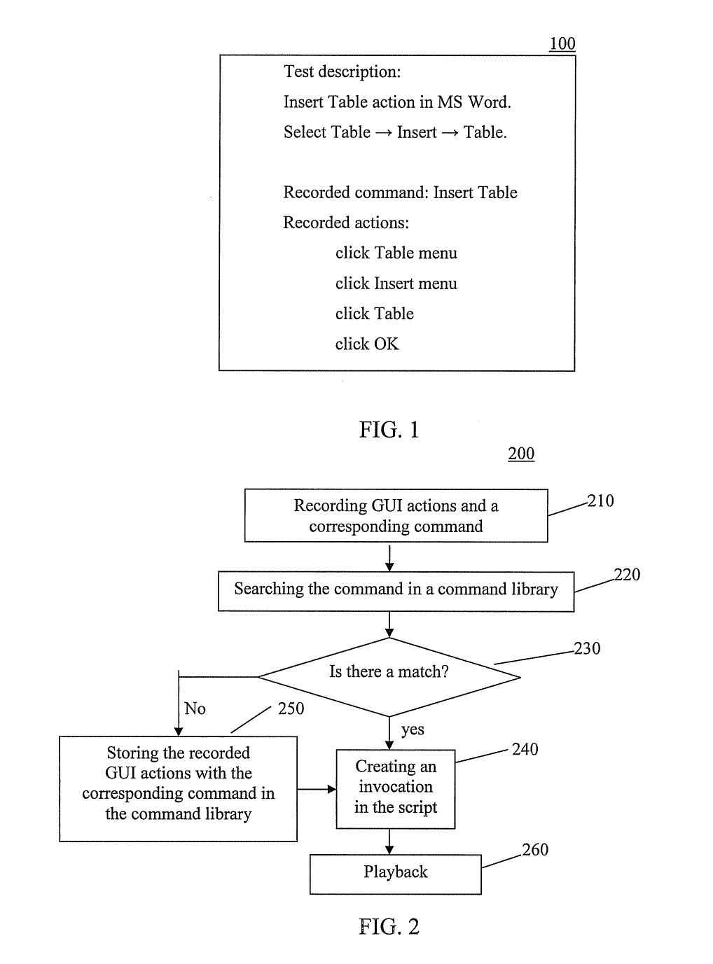

Aspects of the invention can be descriptively illustrated with an example 100 of listening and recording the keyboard/mouse events and command stack as show in FIG. 1. The test to be recorded in this example is the Insert Table functionality in MS Word®, which includes the series of actions of selecting Table menu, then selecting Insert, and then selecting Table. The recorded command is “Insert Table” and the recorded actions include: click Table menu; click Insert menu; click Table, and click OK. The actions and the command are recorded in parallel and the recorded actions will be grouped under the command “Insert Table.” As can be seen in FIG. 1, the recorded actions (click Table menu; click Insert menu; click Table, and click OK) are grouped under the command (“Insert table”) to create a semantic block, which improves the readability of the script and thus the maintainability. For example, Eclipse® offers the possibility of listening to the command stack as well as user actions in parallel.

The playback can be carried out on the command level or the action level, although on the action level is preferred because it is closer to actual user interaction. For example, in the example shown in FIG. 1, the playback can be carried out on the command level by executing the command “Insert Table,” or be carried out on the action level by playing back the action sequence (click Table menu; click Insert menu; click Table, and click OK) directly.

It is noted that although the Eclipse® command stack is used in the above example, the inventive concept of the present invention is not limited to Eclipse®. It is also noted that the invention provides a mechanism by which semantically-meaningful blocks can be created, without changing the nature of the recorded steps within the blocks themselves. It is further noted that the examples as described above are merely for the purpose of illustration and the present invention is not limited to these examples and further modifications or refinements in the scope of the present invention are possible.

Exemplary steps of one method 200 of automated GUI test recording/playback according to the present invention are shown in the flow chart of FIG. 2. In this example, it is assumed that the system under test is an Eclipse®-based Java ® application. Both the Rational® Functional Tester or Eclipse® TPTP Automatic Recorder could be extended to carry out the present invention.

As shown in FIG. 2, at step 210, a listener of the Eclipse® command stack events is registered. The events captured by the listener are used to determine the boundaries of a single command (the same mechanism is used in Eclipse® for undo/redo). At the same time, the GUI actions are also recorded by a keyboard/mouse action listener.

At steps 220 and 230, a command library is searched to determine if the recorded command is already in the command library, namely if there is a match of the recorded command with any command in the command library. If the recorded command matches with a command in the command library, no new command is created in the command library, and only an invocation is created in the script at step 240. If the recorded command does not match any command in the command library, the recorded GUI actions with the corresponding command name are stored in the command library to create a new command at step 250 and an invocation is created in the script at step 240. This enables automatic creation of the command library, and comparison of subsequently recorded commands with the command library to reduce redundancy and improve code reuse.

At step 260, the command is executed invoking the corresponding user actions from the command library. It is noted that generic user actions which are equivalent but not necessarily the same as the recorded actions from the command library will be replayed.

The invention can be realized in hardware, software, or a combination of hardware and software. The invention can be realized in a centralized fashion in one computer system or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention can be implemented with computer-readable code embedded in a computer program product, such as a computer-readable storage medium, which comprises all the features enabling the implementation of the methods described herein, and which when loaded in a computer system is able to cause the computer system to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing descriptions of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

1. A method of automated graphical user interface (GUI) test recording/playback in which a script is generated, comprising:
recording a GUI action including at least one action step and a command corresponding to the recorded GUI action;
searching existing commands in a command library to determine if there is a match of the recorded command with any command in the command library,
if no match is found, storing the recorded GUI action with the corresponding command in the command library and creating an invocation in the script, and
if a match is found, creating an invocation in the script; and
at playback, executing the command, invoking the corresponding user action from the command library.

2. The method of claim 1, wherein the GUI action and the corresponding command are recorded simultaneously.

3. The method of claim 1, wherein the GUI action is recorded by a GUI action listener and the command is recorded by a command stack listener.

4. The method of claim 3, wherein the command stack listener captures command stack events in order to determine the boundaries of a single command.

5. The method of claim 1, wherein the recorded GUI action includes several action steps, and the action steps are automatically grouped at a command level to thereby create a semantic block.

6. The method of claim 5, further comprising merging and adding parameters to the semantic block for executing the command with different parameters.

7. A system of automated GUI test recording/playback in which a script is generated, comprising:
a GUI action listener for recording a GUI action including at least one action step;
a command stack listener for recording a command corresponding to the GUI action;
a command library for storing the recorded GUI action with the corresponding command;
a searching tool for searching existing commands in the command library to determine if there is a match of the recorded command with any command in the command library, wherein if no match is found, the recorded GUI action with the corresponding command is stored in the command library and an invocation is created in the script, and if a match is found, no new command is created in the command library and an invocation is created in the script; and
a play-back tool for executing the command, invoking the corresponding user actions from the command library.

8. The system of claim 7, wherein the GUI action and the corresponding command are recorded simultaneously.

9. The system of claim 7, wherein the command stack listener captures command stack events in order to determine boundaries of a single command.

10. The system of claim 7, wherein the GUI action includes several action steps.

11. The system of claim 10, further comprising a grouping tool for automatically grouping recorded GUI action steps at a command level to thereby create a semantic block.

12. The system of claim 7, further comprising a merging-and-adding tool for merging and adding parameters to the semantic block.

13. A computer-readable storage medium on which computer-executable codes are stored, wherein the computer-executable codes, when loaded, cause the computer to perform:
recording a GUI action including at least one action step and a command corresponding to the recorded GUI action;
searching existing commands in a command library to determine if there is a match of the recorded command with any command in the command library,
if no match is found, storing the recorded GUI action with the corresponding command in the command library and creating an invocation in the script, and
if a match is found, creating an invocation in the script; and
at playback, executing the command, invoking the corresponding user action from the command library.

14. The computer-readable storage medium of claim 13, wherein the computer-executable codes further cause the computer to record the GUI action and the corresponding command simultaneously.

15. The computer-readable storage medium of claim 13, wherein the GUI action is recorded by a GUI action listener and the command is recorded by a command stack listener.

16. The computer-readable storage medium of claim 15, wherein the command stack listener captures command stack events in order to determine the boundaries of a single command.

17. The computer-readable storage medium of claim 13, wherein the recorded GUI action includes several action steps, and the action steps are automatically grouped at a command level to thereby create a semantic block.

18. The computer-readable storage medium of claim 17, the computer-executable codes further cause the computer to merge and add parameters to the semantic block for executing the command with different parameters.
